(19) United States
(12) Patent Application Publication
(10) Pub. No.: US 2016/0335113 A1
(43) Pub. Date: Nov. 17, 2016

(54) AUTOMATED VIRTUAL DESKTOP PROVISIONING

(71) Applicants: John Gorst, Gig Harbor, WA (US); Will Horne, Gig Harbor, WA (US)

(72) Inventors: John Gorst, Gig Harbor, WA (US); Will Horne, Gig Harbor, WA (US)

(21) Appl. No.: 15/155,899

(22) Filed: May 16, 2016

Related U.S. Application Data
(60) Provisional application No. 62/162,598, filed on May 15, 2015.

(51) Int. Cl. G06F 9/455; G06F 9/50

(52) U.S. Cl. CPC G06F 9/45558; G06F 9/5027

(57) ABSTRACT

Methods, systems, and techniques for automated provisioning of virtual desktops are provided. Example embodiments provide an Automated Virtual Desktop Provisioning System (“AVDPS”), which enables users to perform self-service provisioning of virtual desktops with little knowledge other than a proper license. The AVDPS is able to accomplish this through the use of pre-configured Blueprints and Templates. The Blueprints fully specify how a particular resource, for example, an application, services, or virtual infrastructure like memory, CPUs, disk space, etc., is to be installed in a user's virtual desktop(s). The Templates provide master images for a virtual infrastructure image instance (e.g., a virtual machine instance). In an example AVDPS, a single virtual infrastructure image instance supports multiple users at one time—avoided need to supply each user with its own virtual machine image and corresponding resources just in order to have a virtual desktop to access resources, for example applications.

### CROSS-REFERENCE TO RELATED APPLICATIONS

This application claims the benefit of U.S. Provisional Patent Application No. 62/162,598, entitled “SELF-SERVICE CLOUD PROVISIONING SYSTEM AND METHOD,” filed May 15, 2015, which is incorporated herein by reference in its entirety.

### TECHNICAL FIELD

The present disclosure relates to methods, techniques, and systems for provisional virtual desktops to consumers and, in particular, to methods, techniques, and systems for automating the provisioning of virtual desktops using consumer friendly ordering in conjunction with preconfigured provisioning instructions and preconfigured virtual images that support automated provisioning.

### BACKGROUND

These days people want to work or access their digital persona or workbench from everywhere. It has become very convenient to provide a workforce with virtualized desktops—desktops that access applications, data, and other resources, that are not physically stored on their local PCs, tablets, etc., but rather are made accessible through a complex network of IT infrastructure known as virtualization or by accessing applications, documents, and data in the cloud (e.g., via the Internet or other public wide area network). This way, a worker can work—play—access—his or her personal data and applications from anywhere, at any time, and from a variety of device footprints.

One problem with this scenario is that the set up required can be time consuming and require technical expertise that an average user, and even an average IT system administrator does not have.

Set up of a virtualization environment in particular, especially those that allow access to multiple types of applications and resources can be daunting. For example, set up for a single user or, even at the other extreme, for a group containing perhaps hundreds of thousands of users (such as for a medium size to large company) requires a great deal of expertise to wade through platform specific documents and requirements to set up the virtual machines, images, infrastructure required, let alone to allocate virtual desktops with specific permissions and specific resources to users. Without learning the specifics of the virtualization platform, the user and even IT administrator stands little chance of being successful in a time effective manner.

### BRIEF DESCRIPTION OF THE DRAWINGS

FIG. 1 is a block diagram of example components of an example Automated Virtual Desktop Provisioning System.

FIGS. 2A-2B are an overview of the logic performed by an example Provisioning Component of an example Automated Virtual Desktop Provisioning System to specify and allocate provisioning tasks based upon a consumer order.

FIG. 3 is an example flow diagram of logic employed by an example Provisioning Component of an example Automated Virtual Desktop Provisioning System to determine a target virtual infrastructure image instance.

FIG. 4 is a block diagram of an example blueprint data structure.

FIGS. 5A-5B are block diagrams illustrating structure of example Templates.

FIG. 6 is an example flow diagram of logic employed by an example provisioning engine of an Automated Virtual Desktop Provisioning System to perform a provisioning task to provision or update a virtual desktop.

FIG. 7 is an example block diagram of a computing system for practicing embodiments of an example Automated Virtual Desktop Provisioning System.

### DETAILED DESCRIPTION

Embodiments described herein provide enhanced computer- and network-based methods, techniques, and systems for provisioning virtual desktops automatically, without a user needing to configure the virtual desktop image either initially or subsequently to make changes to the user's desktop and resources available to be accessed by the user. Here a user may refer to either the IT administrator who desires to provision virtual desktops to, for example, workers in a company, or to the actual consumer of the desktop. Thus, the embodiments describe a “self-service” architecture for easily provisioning virtual desktops without advanced user knowledge or expertise.

Example embodiments provide an Automated Virtual Desktop Provisioning System (“AVDPS”), which enables users to perform this self-service provisioning of virtual desktops with little knowledge other than a proper license (typically paid for through an ordering system). The AVDPS is able to accomplish this through the use of pre-configured Blueprints and Templates (or Template Images). The Blueprints fully specify how a particular resource, for example, an application, services, or virtual infrastructure like memory (e.g., vRAM), CPUs, disk space, etc., is to be installed in a user's virtual desktop(s). The Templates provide master images for a virtual infrastructure image instance (e.g., a virtual machine instance). In some example AVDPSs, a single virtual infrastructure image instance supports multiple users at one time—avoiding the need to supply each user with its own virtual machine image and corresponding resources simply in order to have a virtual desktop to access resources, for example applications.

When a user places an “order” for particular resource, the corresponding Blueprint(s) are determined. The AVDPS uses information about the user account, the information contained in the Blueprint(s) that correspond to the ordered resources, and information associated with the user to figure out which Template to use to provision an initial virtual infrastructure image instance or which virtual infrastructure image instance is already allocated to the user in order to modify a user's existing virtual desktop (as implemented by a virtual infrastructure image instance). In one example embodiment, a Blueprint specifies whether the corresponding resource is to be installed directly as an image, or requires a script or to be streamed in order to be installed. A Blueprint can also specify that its corresponding resource is to be installed manually or with special instructions that may require user/administrator intervention. It is the first three types of resources—those that can be installed as an image, by streaming, or by script—that can be automatically provisioned by the AVDPS. Thus, by simply ordering the desired resources, the user has specified sufficient information to make available the resources desired. This is in direct contrast to current methods for provisioning virtual desktops which require lots of expertise regarding virtualization infrastructure and typically require an administrator to provision a virtual desktop for a specific user or group of users.

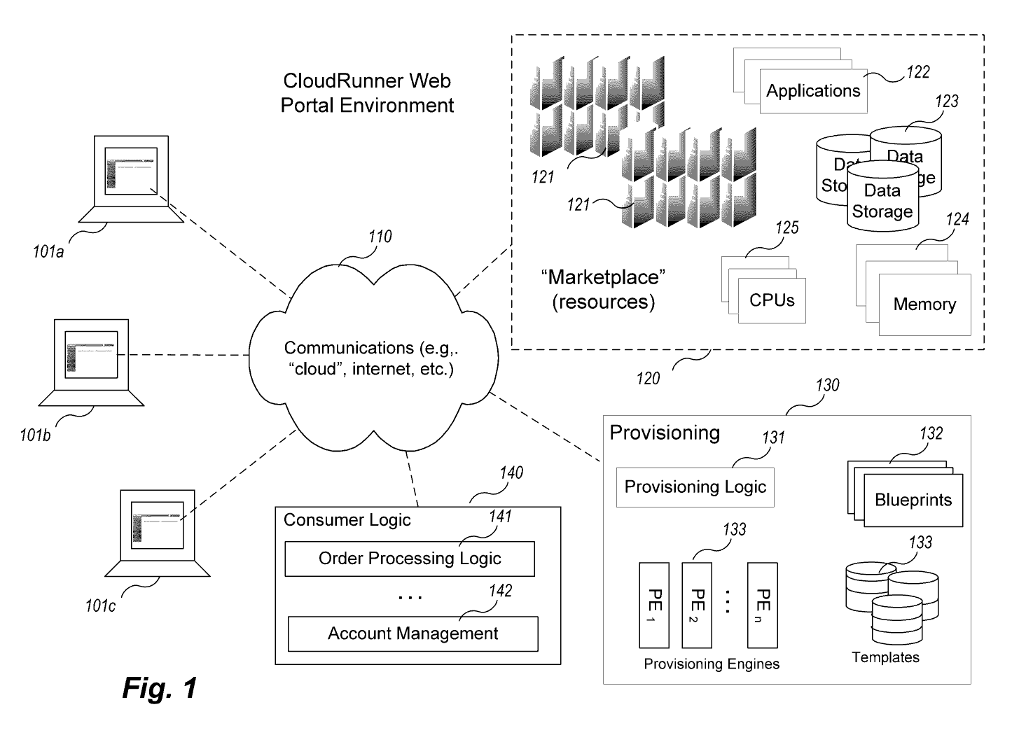

FIG. 1 is a block diagram of example components of an example Automated Virtual Desktop Provisioning System. FIG. 1 illustrates an AVDPS in a web based environment, where the desktops and resources are provisioned “in the cloud.” This means that the desktops and resources provided by a service (or system) are provisioned on (made accessible from) a server, typically residing in a server farm somewhere, for access by a consumer. One such service is implemented by CLOUDRUNNER™, which can instantly support cloud and remote ITaaS (IT as a service) needs by providing a service that can be white-labeled by other service providers.

The AVDPS, although shown and described as a cloud based service for provisioning desktops, could also be used to provision desktops in a local IT warehouse. As noted below, the server farms used to host the resources available to users may be located in multiple locations throughout the globe. In some example embodiments the user can designate from which server farm the user's virtual desktop (referred to as well as simply “desktop”) may be provisioned and accessed. In other embodiments, the AVDPS determines automatically based upon a set of heuristics or rules what server farm optimally should be used to provision resources and desktops for a particular user(s).

In FIG. 1, users' client devices, for example computing systems 101a-101c, can be used to access an ordering system via a client application such as a web browser. As shown, the web browser accesses the AVDPS services (server-side support for the web portal) through a communications network 110 such as the Internet (or other network communications pathway). The AVDPS provides a marketplace of resources 120 (place, location, website, etc. to order resources) and consumer logic 140 for managing the ordering, licensing, billing, and the like of resources that can be purchased for virtual desktop use. The AVDPS also provides the provisioning tools and infrastructure 130 for actually installing/modifying users' virtual environments. Installing can mean providing actually resource images as well as providing access to a resource.

In an example AVDPS, the consumer logic 140 provides account management services 142 (such as billing, licensing, and the like) and order processing logic 141 that provides an interface for a user to order resources from marketplace 120. In some example AVDPS, components of the consumer logic 140 may be provided externally or through other third parties and may include other services.

An example marketplace 120 includes one or more server farms 121, applications 122, storage 123 (virtual disk, vNAS, etc.), memory 124 (vRAM), one or more CPUs 125, and other compute resources. Other resources may be offered, which may be fewer or greater or different than those shown. As indicated above, a server farm 121 or a portion thereof may be indicated in a user order for specification of locale of the user's resources in case, for example, the user wants a specific location or server(s) used.

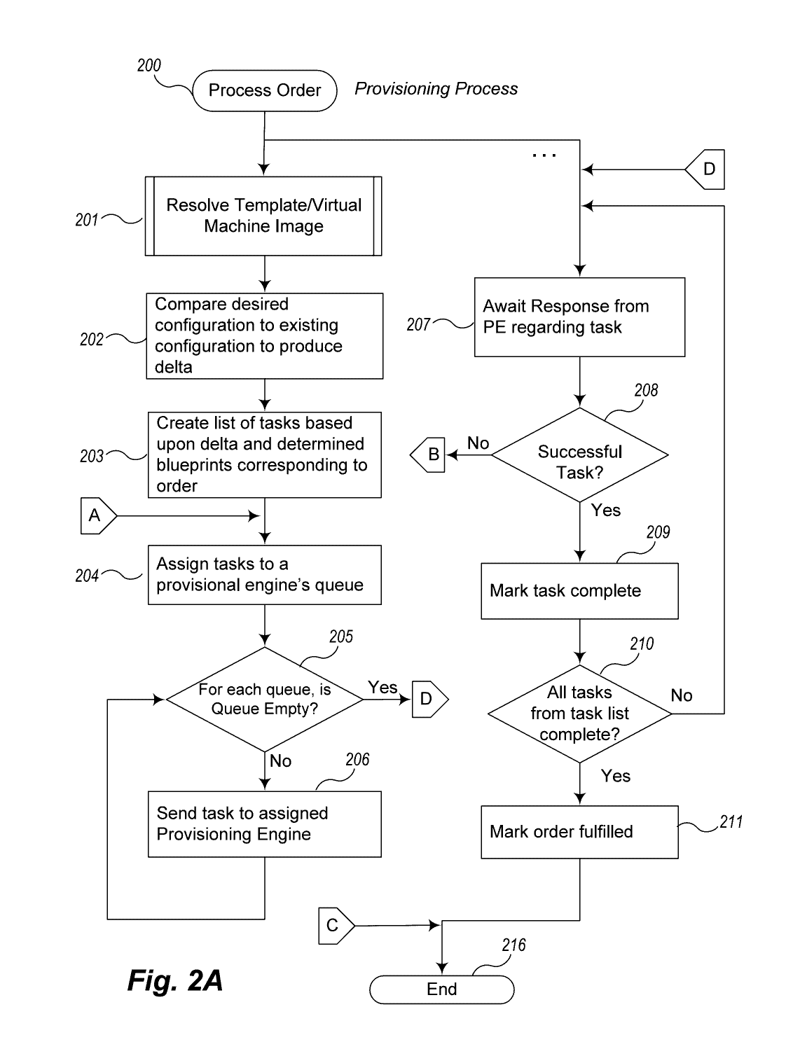

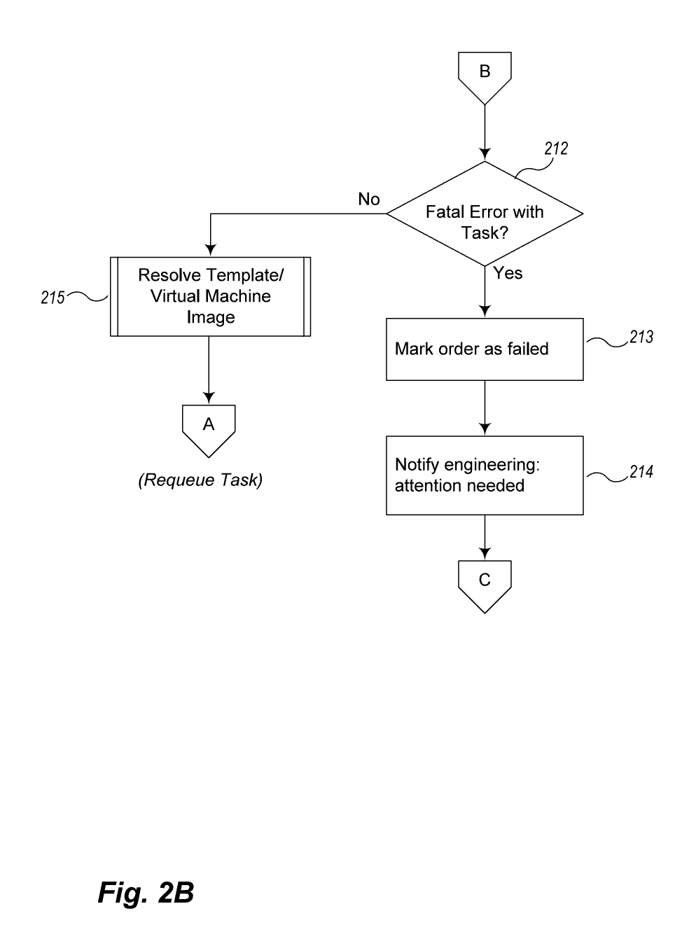

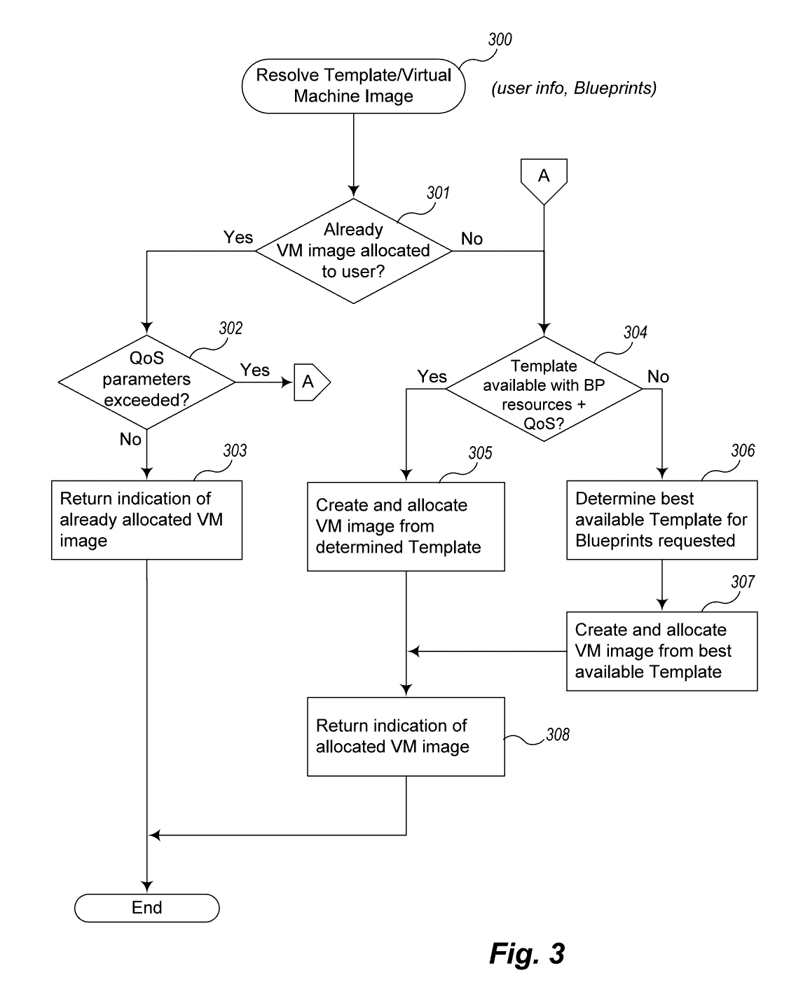

The AVDPS also provides all of the provisioning support 130 to be able to provide the automatic provisioning and delivery of virtual desktops to users. This may include, for example, provisioning logic 131 described further below with respect to FIGS. 2A-B and FIG. 3. The AVDPS also provides a provisioning engine interface (e.g., an applications programming interface—API) which can be implemented by platform specific provisioning engines 133. In some embodiments there are multiple provisioning engines for a particular “brand,” and typically at least one Here a brand refers to the white labeling of the AVDPS provisioning support. In one example AVDPS, there is a different provisioning engine for each different type of provisioning task (“task”) that needs to be performed. For example, there may be a separate provisioning engine provided for a task for modifying a virtual machine, a task that configures an application, or a task that modifies the hypervisor of a virtual machine or some other part of the virtualization infrastructure. Other provisioning engine types are envisioned and incorporated similarly.

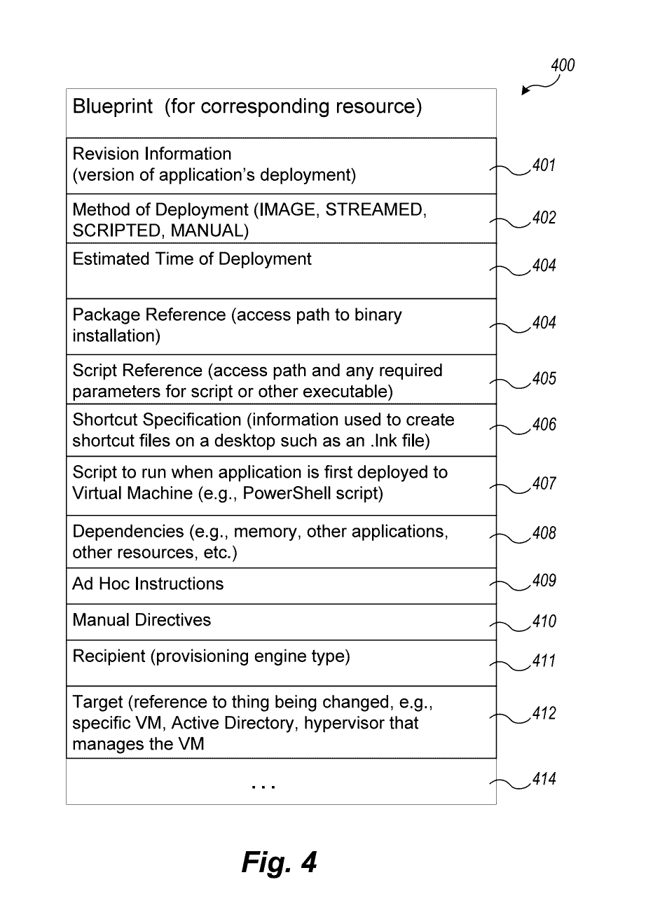

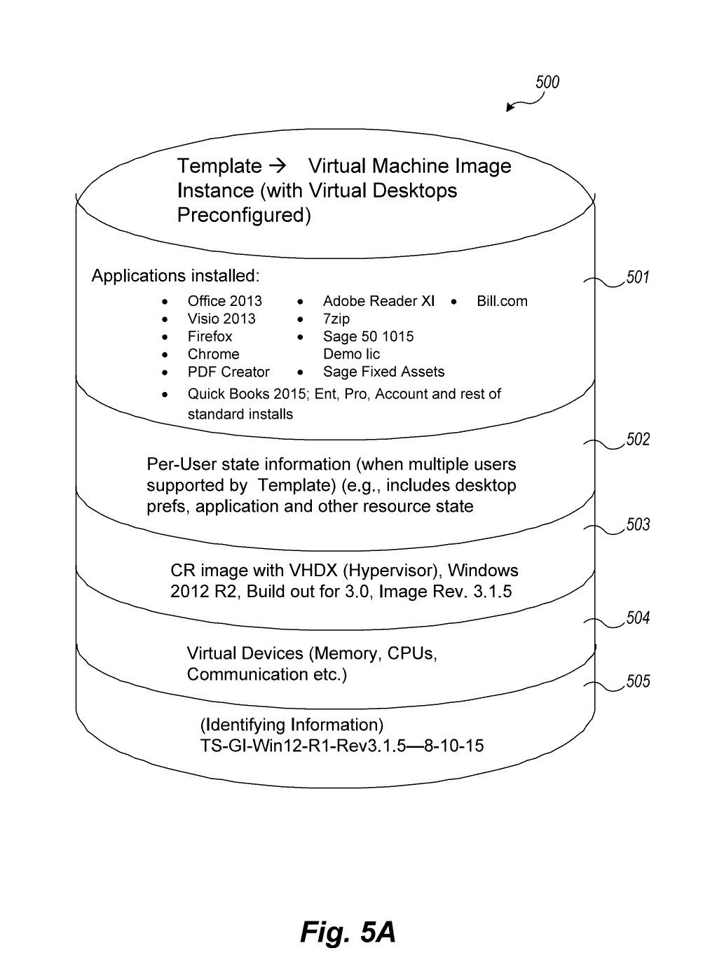

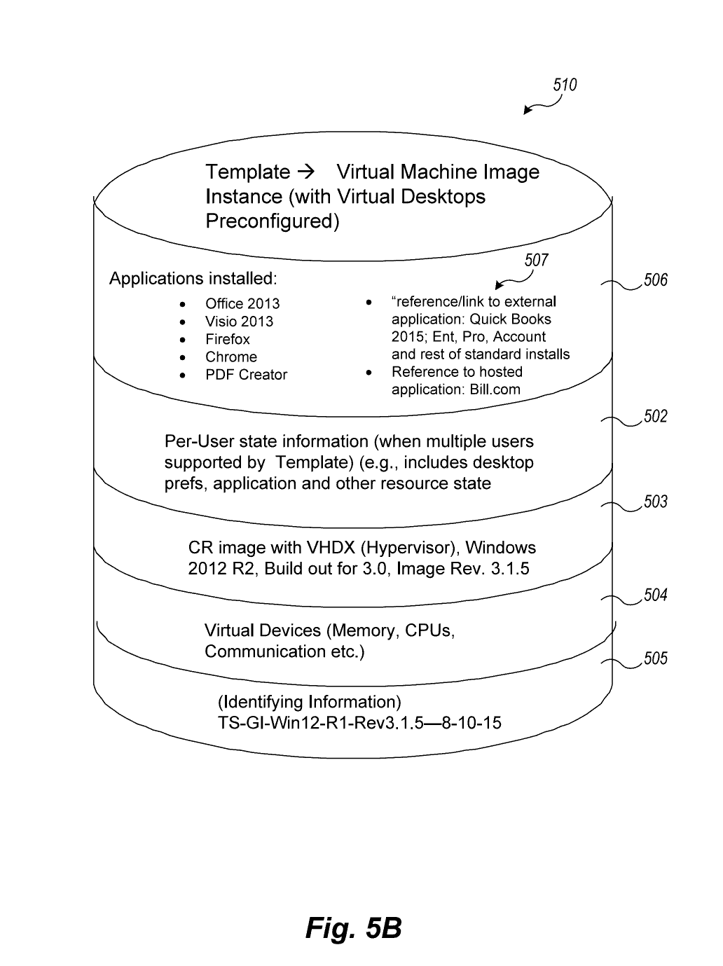

The provisioning support 130 of an AVDPS also includes one or more Blueprints 132 and one or more Templates 133. In one example AVDPS, there is a Blueprint corresponding to each resource that can be ordered. A Blueprint is a data structure that includes sufficient information to provision the corresponding resource in a virtual infrastructure image instance. The Blueprint data structure is described with reference to FIG. 4. A Template is an virtual infrastructure image (e.g., a virtual machine image or other variation of virtualization infrastructure) for use in making a user's virtual desktop. It represents a virtual machine environment having a particular size and with particular resources (installed as an executable or otherwise accessible). Templates are described further with reference to FIGS. 5A-5B.

In brief operation, a user via client device 101x licenses (pays for) particular resources from marketplace 120 using consumer logic 140 and indicates to the AVDPS (for example, with a “configure/buy” user interface control) to go ahead and provision the resources as requested. The provisioning logic 131 then determines the Blueprints 132 and Templates 133, or already allocated virtual infrastructure image instance, that correspond to this order (user, group, organization, brand, etc.) and automatically specifies the provisioning that needs to occur based upon the information in the determined Blueprints, any designated server location, requirements of the requested resources, capabilities of an allocated virtual infrastructure image instance, etc. Behind the scenes, the provisioning support 130 needs to determine issues such as, is the resource request in the order compatible with the virtual environment already allocated to the user, does it have dependencies that require changes to an already allocated virtual environment or between the resources requested, does the virtual environment support required (for example with enough memory, CPU power, etc.) have an undesirable impact on quality of service, etc. Answers to these issues may result in the provisioning support 130 making changes to the user's virtual desktop and infrastructure without the user having to step in or otherwise intervene in the provisioning process after submitting the order. Accordingly, as a result, a user without much technical prowess can order and use a virtual desktop environment.

Although the techniques of Automated Virtual Desktop Provisioning System are generally explained with regard to provisioning applications and other compute resources in a virtual machine image context, these techniques are applicable to provisioning any type of compute resource in any type of virtualization infrastructure, regardless of the underlying platform, applications used, user base, and the like. In addition, the concepts and techniques described are applicable to other environments that require automated provisioning of resources if blueprints can be preconfigured that indicate whether to install the resource as an image, as streamed, by scripting or by some other means of provisioning. Also, although certain terms are used primarily herein, other terms could be used interchangeably to yield equivalent embodiments and examples. In addition, terms may have alternate spellings which may or may not be explicitly mentioned, and all such variations of terms are intended to be included.

In the following description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the logic, different logic, etc. Thus, the scope of the techniques and/or functions described are not limited by the particular order, selection, or decomposition of aspects described with reference to any particular routine, module, component, and the like.

FIGS. 2A-2B are an overview of the logic performed by an example Provisioning Component of an example Automated Virtual Desktop Provisioning System to specify and allocate provisioning tasks based upon a consumer order. The logic of FIGS. 2A-2B is invoked, for example, by the provisioning logic 131 of FIG. 1 to perform automated provisioning.

In block 201, the provisioning logic executes additional logic to determine which virtual infrastructure image instance is to be used to provision the compute resources ordered. This logic is described with reference to FIG. 3. Once determined, the virtual infrastructure image instance may or may not already include the resources to be provisioned. If the image already includes the resources, it is possible for them to merely be “turned on” once the user has proper access rights (licenses, etc.). This can occur if the Template used to create the virtual infrastructure image instance includes all of the requested resources so that they are actually in or accessible from the created virtual infrastructure image instance when enabled.

In block 202, the provisioning logic compares the desired configuration (e.g., what resources the user has ordered) with the existing configuration of the virtual infrastructure image instance to produce a delta—a representation of what is different. A user order may request different types of changes:
Add—A user can add a new resource to an existing configuration. Such changes are usually applications, but can also be resources such as shared storage or email hosting services.
Remove—A user can remove a resource from an existing configuration. Depending upon the resource being removed, this may also trigger the removal of dependencies that are no longer required. Of note, the resource may not be removed, but rather the user's access removed if there are other's using the resource (since some virtual infrastructure image instances support multiple user virtual desktops).
Alteration—For service offerings that can't or shouldn't be removed completely (such as RAM or storage), changes to the configuration are expressed as an Alteration.

From this, in block 203, the provisioning logic creates a list (set, file, or otherwise) of provisioning tasks that need to occur based upon the delta. For example, a task may be to add 3 Gigabytes of virtual RAM (vRAM). As another example, a task may be to provide access to an application such as Office 2013 using the information in a Blueprint that corresponds to the Office 2013 resource. Having this delta and list of provisioning tasks insures that the provisioning process (and order fulfillment) is idempotent—if the fulfillment process is interrupted for whatever reason, it may be reprocessed without generating inconsistent results.

In block 204, once the list of provisioning tasks is created, each task is assigned to the appropriate provisional engine's queue. In one AVDPS, each provisioning task consists of a determined blueprint, a designation of a recipient provisioning engine, and a “target.” As mentioned above, different provisional engines (PEs) may be used for different types of tasks, different marketplaces, users, accounts, companies, etc. For example, a task that modifies the size of the virtual machine instance to accommodate more resources may be forwarded (e.g., sent, messaged, etc.) to a PE responsible for issuing commands to a hypervisor of the target virtual infrastructure image instance. A task that involved adding a user might be sent to a PE responsible for changing entries in the Active Directory server for setting up user profiles. Yet a task that turns on an already installed application image for the user may be forwarded to a different PE instance. In addition, there may be a variety of different PE instances available at different server farm locations. Here, a target refers to the actual thing being changed—it may be a specific virtual infrastructure image instance, the hypervisor that manages that instance, an active directory, etc.

The provisioning tasks are sorted into queues by recipient PE. For example, in blocks 205 to 206, for each PE queue, each task on the queue is forwarded (e.g., via a messaging layer or other interprocess communications mechanism that provides asynchronous message delivery) to the assigned provisioning engine until there are no more tasks on the queue. Since some resources have requirements, in one example AVDPS, a dependency tree is created and traversed recursively, in depth order, (not shown) to generate meaningfully ordered list of tasks for each recipient, and notifying the engineering staff of dependency conflicts. This part of the logic sequence is then complete and the provisioning logic continues to block 207 to await responses from the various provisioning engines. The logic in blocks 207-215 for processing responses may be processed by a separate execution thread or other parallel methods in some AVDPS examples. In any case, block 207 in the particular example shown is interrupt driven by, for example, an interprocess communications mechanism (e.g., when a message from a PE task appears, it is received and handled by block 207).

Once a provisioning task responds, in block 208 the provisioning logic determines whether the task was successful, and if so continues in block 209, otherwise continues in block 212 to process the error.

In block 209, the provisioning logic marks the specific provisioning task as complete. Then, in block 210, the logic determines whether all provisioning tasks have been processed and if so, continues in block 211, otherwise returns to wait for more provisioning task responses in block 207.

In block 211, the provisioning logic marks the order as fulfilled and ends in block 216.

In block 212, the provisioning logic determines whether the noted error is fatal (the task cannot be completed without further adjustment) and, if so, marks the order as failed (block 213) and notifies “engineering” or other responsible organization that attention is needed (block 214). The ordering process is then complete (block 216).

Otherwise, in block 215, the provisioning logic again invokes additional logic (as described with reference to FIG. 3) to determine whether the virtual infrastructure image instance requires modification in a manner that may require creation and allocation of a new virtual infrastructure image instance from a different Template. The provisioning logic then “re-queues” the task (adjusting the task description as necessary if a new target is employed) and returns to block 204.

FIG. 3 is an example flow diagram of logic employed by an example Provisioning Component of an example Automated Virtual Desktop Provisioning System to determine a target virtual infrastructure image instance. This logic may be executed, for example, by the provisioning logic of FIG. 2A in block 201. In overview, the image instance logic either determines whether a target instance is available for the user and can reasonably accommodate the requested changes and maintain quality of service, or whether a new virtual infrastructure image instance needs to be created (e.g., instantiated, copied, or by other techniques) and allocated to the user associated with the order. As explained with respect to FIGS. 5A-5B, each Template, hence virtual infrastructure image instance, may accommodate a plurality of users' virtual desktops.

More specifically, in block 301, the logic determines whether there is already a virtual infrastructure image instance associated with (allocated, assigned, or otherwise corresponding to) the user associated with the order. If so, then the logic continues in block 302, otherwise continues in block 304 to create and allocate a new image based upon a Template.

In block 302, the logic determines whether if the requested resources were to be added, quality of service (QoS) issues would arise. Although this check can be made at other times, performing this early in the provisioning process may speed up processing. Quality of service parameters may include things such as response time, error rates, throughput, transmission delay, availability, and the like. If QoS parameters indicate a potential problem that cannot be solved in the current virtual infrastructure image instance (e.g., resizing, allocating more memory, processors, etc. won't help), then the logic proceeds to block 304 to use another Template to create and allocate a new target virtual infrastructure image instance (e.g., VM) for the user. If QoS parameters dictate an acceptable result (or the VM can be changed), then the logic continues in block 303 to return an indication of the already allocated virtual infrastructure image instance.

In block 304, the logic determines whether a Template virtual infrastructure image (Template) is available that already has preconfigured the resources indicated by the designated blueprints for this order. If so, the logic continues in block 305 to create a new virtual infrastructure image instance from the determined Template and allocated it to the user. In block 308, the logic returns an indication to this newly allocated instance.

If instead no Template is available that perfectly corresponds to the resources indicated by the designated blueprints for this order, then in block 306, the logic must then determine a “best available” Template for the blueprints requested. The determination of best available may be made based upon a variety of factors, including minimizing dependency problems, expansion capabilities, similarity of the resources in the Template to the requested resources (for example, certain Templates may be generated based upon a vertical market segment), or location of the resources relative to each other, QoS considerations, and the like. Other rules and heuristics can be similarly accommodated.

In block 307, once the best Template for the Blueprints corresponding to the requested resources has been determined, the logic proceeds to create and allocate a virtual infrastructure image instance and proceeds to block 308 to return an indication to this newly allocated instance.

FIG. 4 is a block diagram of an example blueprint data structure. Although certain fields are include herein for illustration, it is noted that other fields may be included or removed from those indicated. There is a Blueprint preconfigured for each resource in the system that can be ordered by a user. It is this Blueprint structure that provides the information needed by the provisioning logic (e.g., provisioning logic 131 of FIG. 1) to automatically provision the resource.

In the example shown, a Blueprint data structure 400 comprises several fields 401-414. Blueprints 400 may contact other and/or different fields other than those shown. Identification and/or revision information 401 indicates revision information for the resource. For example, it may be versioning information for an application.

An indication of method of deployment (image, streamed, scripted, or manual) 402 indicates whether the resource is to be deployed by an image preloaded into the virtual infrastructure image instance, is to be streamed to configure the image instance with the resource, a script is to be run to “install” the resource (see above as install may be indirect access) or is to be deployed manually. In some cases the requested resource is an external application not necessarily integrated into the virtual infrastructure image instance (e.g., a legacy host application), but can still be configured for access from the user's virtual desktop.

Estimated time of deployment 404 indicates how long the provisioning will take. For image provisioning this time is zero (or near zero).

Package reference 404 provides an indication of the access path to the binary installation for the corresponding resource. This may be required for applications.

Script reference 405 provides an indication of the access path to the and any required parameters for script installation or other executable.

Shortcut specification 406 provides information that can be used to create shortcuts (e.g. links) to installed applications or other shared resources (e.g., a shared network drive) for convenience of end users.

Script 407 provides a script to run when the application is first deployed in a virtual infrastructure image instance (e.g., using a PowerShell script).

Dependencies 408 documents dependencies and/or other requirements needed by the corresponding resource, such as memory size, other applications, or other drivers, access to shared resources such as a GPU, etc.

Ad Hoc Instructions 409 provides scripts that may be helpful or necessary for non-standard or otherwise exceptional packages or services.

In some cases, when a unique resource or service is requested, or when no practical way to automate the provisioning of the corresponding resource exists, Manual Directives field 410 can be used to provide engineering staff with the necessary information to fulfill the request. It can also act as a placeholder to indicate fulfillment status.

Recipient 411 indicates the provisioning engine type (if known). Target 412 indicates a reference to the what is being changed, for example, the specific virtual infrastructure image instance, an active directory, a hypervisor that manages the VM that is the image instance, and the like.

Other information 414 can similarly be incorporated.

FIGS. 5A-5B are block diagrams illustrating structure of example Templates. As described, a Template is a virtual infrastructure image (e.g., a virtual machine) that is used to instantiate (or otherwise create) an image instance for a user or group of users (e.g., a company, department in a company, and the like). Although other virtual images can be similarly represented in a Template, the ones shown are that of a virtual machine image used to deploy virtual desktops for users. Also, depending upon the particular AVDPS, the virtual infrastructure image may represent virtualization images other than a virtual machine image, for example, a portion of such image.

FIG. 5A illustrates a Template 500 where application executables (and other resources) are preloaded and preconfigured into the image as image portion 501. This corresponds to the provisioning type “Image” discussed with respect to the Blueprint data structure of FIG. 4, field 402. FIG. 5B illustrates a Template 510 where some application executables (and other resources) are preloaded and preconfigured into the image 506, yet other resources 507 are linked from the image to external locations. The remaining fields in the two Templates illustrated are the same.

In particular, field 505 includes identification information for the Template such as what it is and which template revision. Filed 504 contains the virtual devices and other virtual infrastructure needed for the image depending upon what the image is. In this case, a standard virtual machine image includes virtual devices (504) along with a hypervisor, operating system, build of the provisioning logic (503).

Unlike conventional virtual machine images, in some AVDPS Templates, the virtual infrastructure image includes per-user or per-account (depending upon deployment and Template) state information (502) that keeps track of all of the user's desktop state, preferences, application data, and the like. This is because some AVDPS Templates support applications or other resources that have been repackaged/programmed to have “multi-tenant” capabilities. This allows a single resource like an application or service to be shared by multiple users, resulting in a more efficient virtualization infrastructure environment.

In an example AVDPS, there are multiple Templates available based in part upon anticipated needs for customers. For example, there may be Templates with applications and other resources preconfigured along a vertical market line (e.g., accounting, law, etc.), there may be Templates that guarantee certain QoS (e.g., for real-time applications), there may be Templates of certain sizes, or Templates for certain platforms, and the like. The AVDPS can incorporate any such organization.

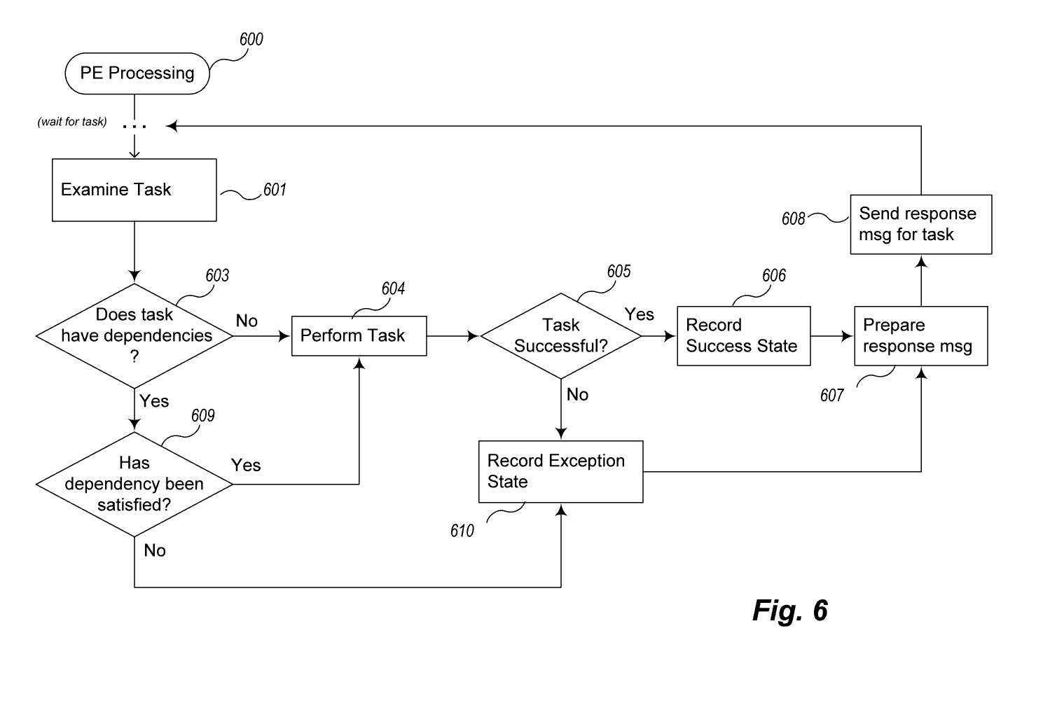

FIG. 6 is an example flow diagram of logic employed by an example provisioning engine of an Automated Virtual Desktop Provisioning System to perform a provisioning task to provision or update a virtual infrastructure image instance. As described with reference to block 206 of FIG. 2A, provisioning tasks are queued and then sent to an appropriate provisioning engine. A provisioning engine implementation is typically platform specific and adheres to the provisioning engine API. It is typically customized to perform provisioning tasks for the platform it represents.

In the example AVDPS shown, the provisioning engine waits for tasks to arrive via asynchronous messaging or other interprocess communications mechanism. When a task arrives, the logic examines the task in block 601. In block 603, the logic determines whether the task is associated with any dependencies. If not, the task is performed in block 604. Otherwise, the logic determines in block 609 whether all of the required dependencies (indicated in the Blueprint used to create the task) have been filled and if so proceeds to block 604 to perform the task.

If a dependency has not been satisfied, the logic proceeds to block 610 to record the exception, prepares a response message (block 607), and sends the response message corresponding to the task back to the provisioning logic (block 608).

Upon performing the task in block 604, the logic the determines in block 605 whether the task was successful. If so the logic proceeds to block 606, other proceeds to block 610 to record the exception, etc.

If the task was successful, then in block 606 the logic records a success state, prepares the response message (block 607) and sends the response message corresponding to the task back to the provisioning logic (block 608).

The logic then returns to the beginning of the loop and waits to process the next task sent to it by the provisioning logic of FIG. 2A.

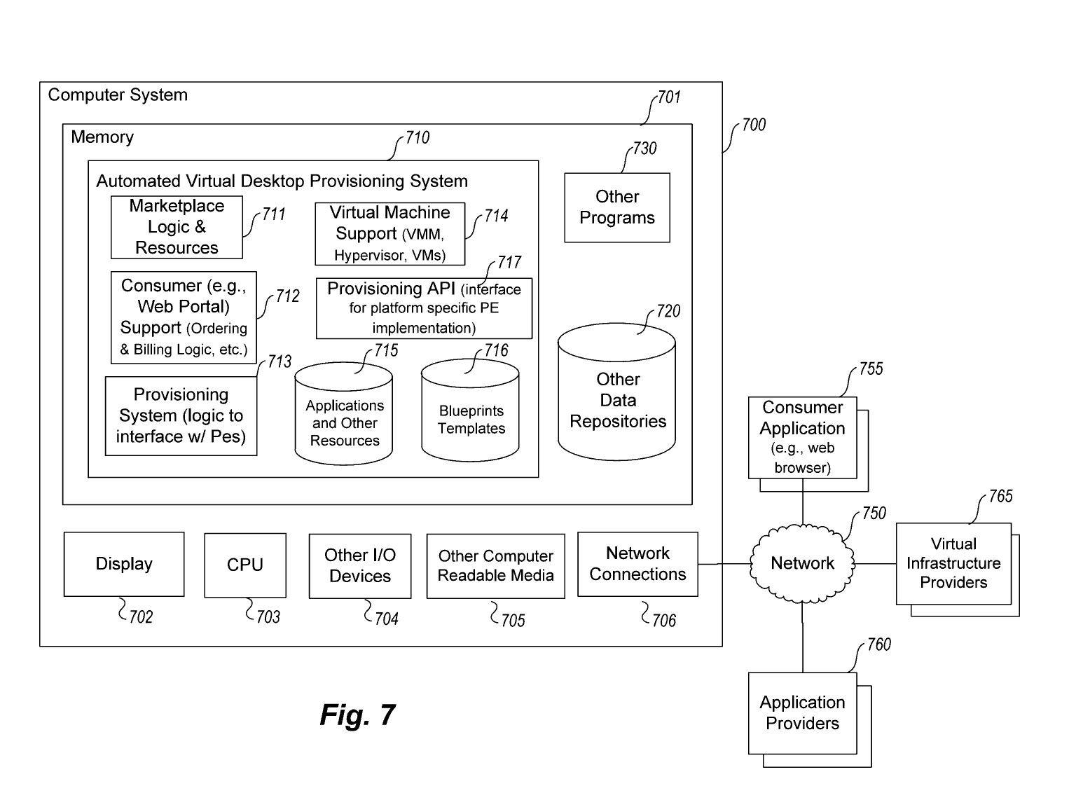

FIG. 7 is an example block diagram of a computing system for practicing embodiments of an example Automated Virtual Desktop Provisioning System described herein. Note that one or more virtual or physical computing systems suitably instructed or special purpose computing systems may be used to implement an AVDPS. Further, the AVDPS may be implemented in software, hardware, firmware, or in some combination to achieve the capabilities described herein.

The computing system 700 may comprise one or more server and/or client computing systems and may span distributed locations. In addition, each block shown may represent one or more such blocks as appropriate to a specific embodiment or may be combined with other blocks. Moreover, the various blocks of the Automatic Virtual Desktop Provisioning System 710 may physically reside on one or more machines, which use standard (e.g., TCP/IP) or proprietary interprocess communication mechanisms to communicate with each other.

In the embodiment shown, computer system 700 comprises a computer memory (“memory”) 701, a display 702, one or more Central Processing Units (“CPU”) 703, Input/Output devices 704 (e.g., keyboard, mouse, CRT or LCD display, etc.), other computer-readable media 705, and one or more network connections 706. The AVDPS 710 is shown residing in memory 701. In other embodiments, some portion of the contents, some of, or all of the components of the AVDPS 710 may be stored on and/or transmitted over the other computer-readable media 705. The components of the Automatic Virtual Desktop Provisioning System 710 preferably execute on one or more CPUs 703 and manage the automated provisioning of virtual desktops and other virtual infrastructure, as described herein. Other code or programs 730 and potentially other data repositories, such as data repository 720, also reside in the memory 701, and preferably execute on one or more CPUs 703. Of note, one or more of the components in FIG. 7 may not be present in any specific implementation. For example, some embodiments embedded in other software may not provide means for user input or display.

In a typical embodiment, the AVDPS 710 includes one or more Marketplace resources/logic 711, one or more ordering and consumer support 712, one or more provisioning systems 713, and virtual machine/infrastructure support 714. A provisioning engine API 717 is provided to implement platform specific provisioning engines. In at least some embodiments, the marketplace logic is provided external to the AVDPS and is available, potentially, over one or more networks 750. Other and/or different modules may be implemented. In addition, the AVDPS may interact via a network 750 with a client application (e.g., web browser) 755 that accesses the provisioning services of the AVDPS, one or more application providers 760, and/or one or more virtual infrastructure support providers 765, such as the provisioning engines specific to a virtualization platform. Also, of note, the Application and other resource data repository 715 may be provided external to the AVDPS as well, for example in a repository accessible over one or more networks 750.

In an example embodiment, components/modules of the AVDPS 710 are implemented using standard programming techniques. For example, the AVDPS 710 may be implemented as a “native” executable running on the CPU 103, along with one or more static or dynamic libraries. In other embodiments, the AVDPS 710 may be implemented as instructions processed by a virtual machine. A range of programming languages known in the art may be employed for implementing such example embodiments, including representative implementations of various programming language paradigms, including but not limited to, object-oriented, functional, procedural, scripting, and declarative.

The embodiments described above may also use well-known or proprietary, synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously and communicate using message passing techniques. Equivalent synchronous embodiments are also supported.

In addition, programming interfaces to the data stored as part of the AVDPS 710 (e.g., in the data repositories 715 and 716) can be available by standard mechanisms such as through C, C++, C#, and Java APIs; libraries for accessing files, databases, or other data repositories; through scripting languages such as XML; or through Web servers, FTP servers, or other types of servers providing access to stored data. The data repositories 715 and 716 may be implemented as one or more database systems, file systems, or any other technique for storing such information, or any combination of the above, including implementations using distributed computing techniques.

Also the example AVDPS 710 may be implemented in a distributed environment comprising multiple, even heterogeneous, computer systems and networks. Different configurations and locations of programs and data are contemplated for use with techniques of described herein. In addition, the [server and/or client] may be physical or virtual computing systems and may reside on the same physical system. Also, one or more of the modules may themselves be distributed, pooled or otherwise grouped, such as for load balancing, reliability or security reasons. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) and the like. Other variations are possible. Also, other functionality could be provided by each component/module, or existing functionality could be distributed amongst the components/modules in different ways, yet still achieve the functions of an AVDPS.

Furthermore, in some embodiments, some or all of the components of the AVDPS 710 may be implemented or provided in other manners, such as at least partially in firmware and/or hardware, including, but not limited to one or more application-specific integrated circuits (ASICs), standard integrated circuits, controllers executing appropriate instructions, and including microcontrollers and/or embedded controllers, field-programmable gate arrays (FPGAs), complex programmable logic devices (CPLDs), and the like. Some or all of the system components and/or data structures may also be stored as contents (e.g., as executable or other machine-readable software instructions or structured data) on a computer-readable medium (e.g., a hard disk; memory; network; other computer-readable medium; or other portable media article to be read by an appropriate drive or via an appropriate connection, such as a DVD or flash memory device) to enable the computer-readable medium to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

One example AVDPS embodiment, the CLOUDRUNNER™ provisioning system, is described in the documents included in the Appendices, which are incorporated herein by references in their entireties.
Appendix A—Brief description of the CLOUDRUNNER™ platform;
Appendix B—Provisioning configuration;
Appendix C—Technical installation and operational guidelines;
Appendix D—Illustrative screenshots of embodiment of system and method;
Appendix E—Application provisioning;
Appendix F—New domain creation;
Appendix G—Deployment example;
Appendix H—Exemplar firewall and switch configuration;
Appendix I—Exemplar physical hardware configuration;

All of the above U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 62/162,598, entitled “SELF-SERVICE CLOUD PROVISIONING SYSTEM AND METHOD,” filed May 15, 2015, is incorporated herein by reference, in its entirety.

From the foregoing it will be appreciated that, although specific embodiments have been described herein for purposes of illustration, various modifications may be made without deviating from the spirit and scope of the invention. For example, the methods and systems for performing automatic provisioning of virtual desktops discussed herein are applicable to other architectures other than a web-based architecture. For example, they may be used with a private IT infrastructure connected via non-public networks. Also, the methods and systems discussed herein are applicable to differing app specific protocols, communication media (optical, wireless, cable, etc.) and devices (such as wireless handsets, electronic organizers, personal digital assistants, portable email machines, game machines, pagers, navigation devices such as GPS receivers, etc.).

1. A method in a computing system for automatically provisioning a virtual desktop on a server computing system, in response to a request, comprising:
receiving an order requesting one or more corresponding resources to be provisioned in a virtual desktop of a user; and
automatically, without further configuration from the user, provisioning the virtual desktop on the server computing system by:
provisioning a virtual infrastructure image instance to accommodate the requested resources by automatically determining preconfigured blueprint data structures having populated fields that each describe a corresponding resource and information to automatically provision the corresponding resource; and
provisioning the resources corresponding to the determined blueprint data structures based upon the fields in the determined blueprint data structures.

2. The method of claim 1 wherein each preconfigured blueprint data structure comprises a unique identifier, an indication of whether the corresponding resource is to be provisioned as an image in the virtual infrastructure image instance or otherwise provisioned through use of additional instructions or mechanisms, and an access path when the indication of whether the resource is to be provisioned as an image or otherwise provisioned indicates that the corresponding resource is to be otherwise provisioned.

3. The method of claim 2 wherein the indication of whether the corresponding resource is to be otherwise provisioned indicates that the resource is to be streamed or installed via a script.

4. The method of claim 1 wherein the automatically provisioning the virtual infrastructure image instance to accommodate the requested resources further comprises:
determining whether a virtual infrastructure image instance has already been allocated for the user and can accommodate the requested resources;
when determined that a virtual infrastructure image instance has not yet been allocated or cannot handle the requested resources,
determining a template virtual infrastructure image that corresponds to the determined blueprint data structures;
creating a new virtual infrastructure image instance based upon the determined template virtual infrastructure image; and
allocating the new virtual infrastructure image instance to the user and determining that the allocated virtual infrastructure image instance is the current; and
causing one or more provisioning tasks to be executed to provision the requested resources with respect to the allocated virtual infrastructure image instance or the allocated new virtual infrastructure image instance based upon the blueprint data structures corresponding to each of the requested resources.

5. The method of claim 4 wherein the allocated virtual infrastructure image instance and/or the allocated new virtual infrastructure image instance are virtual machine image instances.

6. The method of claim 4 wherein creating a new virtual infrastructure image instance based upon the determined template virtual infrastructure image further comprises:
evaluating available template virtual infrastructure images to determine whether a template virtual infrastructure image already exists with the requested resources;
when determined that a template virtual infrastructure image does not yet exist with the requested resources, determining a template virtual infrastructure image that best accommodates the requested resources based upon resource requirements and quality of service parameters.

7. The method of claim 7 wherein the quality of service parameters include response time.

8. The method of claim 7 wherein the resource requirements dictate size of a virtual infrastructure image needed to accommodate the requested resources.

9. The method of claim 4 wherein the determining whether an allocated virtual infrastructure image instance can accommodate the requested resources determines whether the allocated virtual infrastructure image instance meets the resource requirements specified by the determined blueprint data structures and quality of service parameters.

10. The method of claim 1 wherein the automatically provisioning a virtual infrastructure image instance to accommodate the requested resources provisions at least some of the resources as images directly residing in the virtual infrastructure image instance to result in near instantaneous provisioning of the requested resources.

11. The method of claim 1 wherein the resource refers to at least one of an application, memory, storage, CPU, or service.

12. The method of claim 1 wherein the automatically provisioning the virtual desktop on the server computing system is initiated via a web portal.

13. A virtual desktop provisioning computing system, comprising:
a memory;
a computer processor;
one or more compute resources that can be ordered by a user; and
a provisioning component, stored in the memory, comprising:
preconfigured blueprint data structures having populated fields that each describe a corresponding resource and information to automatically provision the corresponding resource; and
provisioning logic configured, when executed, to:
automatically determine the preconfigured blueprint data structures corresponding to one or more computer resources ordered by the user; and
automatically provision the one or more computer resources ordered by the user in a virtual desktop associated with the user based upon the fields in the determined blueprint data structures without further configuration from the user.

14. The computing system of claim 13 wherein the provisioning component further comprises:
one or more template virtual infrastructure images;
and wherein the provisioning logic is further configured to automatically provision the one or more computer resources ordered by the user using a virtual infrastructure image instance created based upon a determined template virtual infrastructure image.

15. The computing system of claim 14 wherein the virtual infrastructure image instance created based upon the template virtual infrastructure image supports a plurality of users at the same time.

16. The computing system of claim 15 wherein the virtual infrastructure image instance contains state information for each user supported by the image instance.

17. The computing system of claim 14 wherein the determined template virtual infrastructure image is determined based upon system requirements of the ordered computer resources and/or quality of service parameters.

18. The computing system of claim 13 wherein the preconfigured blueprint data structures indicate whether the corresponding resources is to be provisioning as an image, by streaming, or by running a script.

19. The computing system of claim 13 wherein the preconfigured blueprint data structures include additional instructions to be executed after the corresponding resource is provisioned in the virtual desktop.

20. The computing system of claim 13, further comprising:
order processing programming logic structured to present a user interface for ordering resources, process orders of resources to be provisioned including determine licenses for access to the ordered resources.

21. A non-transitory computer-readable storage medium containing instructions for controlling a computer processor to perform a method comprising:
receiving an order requesting one or more compute resources to be provisioned in a virtual desktop of a user; and
automatically provisioning the virtual desktop by:
provisioning a virtual infrastructure image instance to accommodate the requested compute resources by automatically determining preconfigured blueprint data structures having populated fields that each describe a corresponding resource and information to automatically provision the corresponding compute resource; and
provisioning the compute resources corresponding to the automatically determined blueprint data structures based upon values of the fields in the determined blueprint data structures.
